(19) United States
(12) Patent Application Publication
(10) Pub. No.: US 2005/0033591 A1
(43) Pub. Date: Feb. 10, 2005

(54) Marketing method for generating revenue

(76) Inventor: Katherine J. Brolley, North York (CA)

Correspondence Address: BERESKIN AND PARR, SCOTIA PLAZA, 40 KING STREET WEST-SUITE 4000 BOX 401, TORONTO, ON, M5H 3Y2, CA

(21) Appl. No.: 10/739,533

(22) Filed: Dec. 19, 2003

Related U.S. Application Data
(60) Provisional application No. 60/434,400, filed on Dec. 19, 2002.

(30) Foreign Application Priority Data
Feb. 5, 2003 (CA) 2,417,557

(51) Int. Cl. G06F 17/60

(52) U.S. Cl. 705/1; 705/7

(57) ABSTRACT

A method of generating clientele by an agent of a business prohibited from direct solicitation is described. The method includes the agent requesting from an established client of the business a referral for a prospective client. The method also includes the established client referring the prospective client to the business, and, in response, the prospective client contacting the business. Subsequently, a representative of the business obtains authorization from the prospective client to provide information about products and services of the business.

### CROSS REFERENCE TO RELATED APPLICATIONS

This application claims priority to U.S. Provisional Application No. 60/434,400, filed on Dec. 19, 2002.

### FIELD OF THE INVENTION

The invention relates to marketing, and more specifically to marketing methods for generating revenue in industries prohibited by law from direct soliciting.

### BACKGROUND OF THE INVENTION

The cemetery and funeral services industries have recently experienced large changes in the way they operate. In part, these changes have been mandated by government. For example, in many jurisdictions, legislation has been introduced to prohibit an agent of a cemetery or funeral business from direct solicitation. Under such legislation, it is unlawful to contact a prospective client without first receiving authorization from such person for that purpose.

From a public policy perspective, such legislation has been viewed favorably because it prevents unscrupulous salespeople from intruding and exploiting a member of the public at times when that member may be vulnerable due to a recent death in the family. Although welcome for this reason, the legislation has had a negative impact on some cemetery or funeral businesses that relied on direct marketing to increase clientele. For example, cold calls to prospective clients to solicit business, once a widely used practice in the cemetery and funeral business, may now be prohibited. Consequently, any method of marketing for the funeral and cemetery industries that is both effective and compliant with laws that curtail marketing activities in these industries would be welcome.

### SUMMARY OF THE INVENTION

In accordance with the present invention, a method is provided for generating clientele by an agent of a business prohibited from direct solicitation. For example, the business can be a cemetery or funeral service business prohibited by law from marketing products and services directly to a prospective client via telephone or other means without the express prior approval of the prospective client.

The method includes the agent requesting from an established client of the business a referral for a prospective client. The method also includes the established client referring the prospective client to the business, and, in response, the prospective client contacting the business. The method further includes a representative of the business obtaining authorization from the prospective client to provide information about products and services of the business.

The updating of an information profile of the established client may serve as an opportunity for the agent to request the referral. For example, if the information profile contains information about relatives of the established client, a question to the established client about relatives can be a segue for the request of the referral for the relative.

Another method of generating clientele by an agent of a business prohibited from direct solicitation is also described herein that involves a personal profile. The method includes the agent meeting a client of the business to update an information profile of the client, and at the meeting, obtaining authorization from the client to provide information about products and services of the business to the client.

Also described herein is a method of generating clientele for a cemetery business. The method includes obtaining a client of the cemetery business, and providing a heritage record for the client, the heritage record including personal information about the client and affording the client a means to communicate information to a designated person. For example, the client may want to communicate information to a next of kin when the client dies.

The method further includes obtaining authorization from the client to disclose a selected portion of the heritage record to the designated person. When the designated person visits the cemetery business to access the heritage record, the business can obtain authorization from the designated person to provide information about future products and services.

Also described herein is a method of generating fees for a central enterprise from an associate business. The method includes a) forming a client base of the associate business, and b) distributing a promotion card to each member of the client base. The promotion card allows each member to obtain a benefit when making a purchase at a participating supplier of products or services, such as a discount or frequent purchase points redeemable. The participating supplier can include a retail business that supplies products or services to customers. Further steps of the method include c) contacting each member of the client base to obtain information to form a member file, and d) from the member file of each member of the client base, identifying a particular subgroup of the client base. Subsequently, the members of the subgroup are invited to a workshop to provide information and to direct market the associate business to the members of the subgroup. In consideration for helping perform at least one of the steps a)-d), the central enterprise receives a fee from the associate business.

### BRIEF DESCRIPTION OF THE DRAWINGS

FIG. 1 shows a flowchart of a method for generating clientele by an agent of a business prohibited from direct solicitation, according to the teachings of the present invention.

FIG. 2 shows a flowchart of a method for generating clientele by using a heritage record, according to the teachings of the present invention.

FIG. 3 shows a flowchart of a method for generating fees for a central enterprise from an associate business, according to the teachings of the present invention.

### DETAILED DESCRIPTION OF THE INVENTION

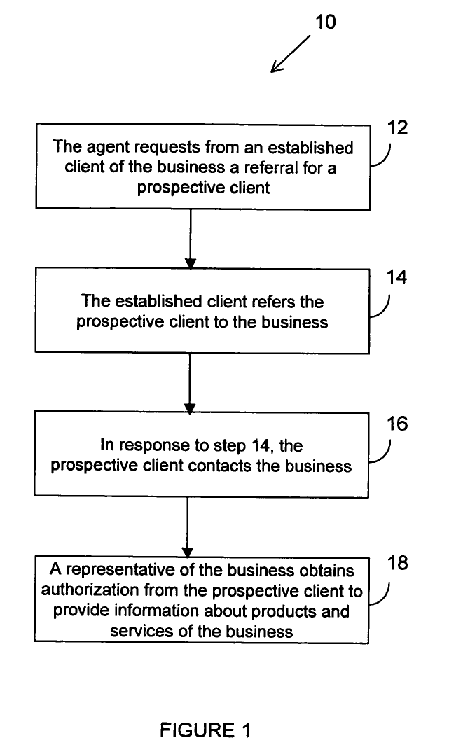

FIG. 1 shows a flowchart of a method 10 for generating clientele by an agent of a business prohibited from direct solicitation. For example, such a business can include a cemetery or funeral service business prohibited by law from contacting clients for the purpose of direct marketing without authorization.

In step 12, the agent requests from an established client of the business a referral for a prospective client. In step 14, the established client refers the prospective client to the business. In response to the step of referring, the prospective client contacts the business in step 16. Subsequently, in step 18, a representative of the business, who may be the same or a different person than the agent, obtains authorization from the prospective client to provide information about products and services of the business. Such authorization, which can be obtained by having the prospective client sign an authorization form, allows the business to legally contact the prospective client immediately or in the future to provide information about products and services offered by the business.

In one embodiment, the agent a) personally meets with the established client of the business before the step of requesting a referral 12, and b) at the meeting, updates an information profile of the established client. The agent executes the step of requesting 12 at the meeting.

The information profile can contain personal information of the client such as date of birth, address and citizenship. The information profile can also contain data about relatives or acquaintances of the established client, such as next of kin, number of children, name of spouse, etc. Such an information profile can naturally prompt the agent to ask the established client a question about the relative or the acquaintance that may result in the relative or acquaintance, respectively, becoming the prospective client. In particular, to update the information profile, the agent can ask the established client a question about relatives or acquaintances, which question may then be used as a segue for the step of requesting a referral.

For example, if the business is a cemetery business and the agent asks the established client for the names of the client's children to update the information profile, the agent may use this opportunity to ask if the children would be interested in receiving information about cemetery services.

In this example, in step 14, the established client can contact one of the established client's children to refer the child (the prospective client) to the cemetery business. In turn, if interested, the child contacts the cemetery business to schedule a meeting in step 16. The established client may accompany the prospective client during this meeting.

The step 18 of obtaining authorization can be executed during the meeting between a representative of the business, which can be the agent, and the prospective client. The authorization may be obtained by having the prospective client sign an authorization form that permits the business to contact the prospective client to provide information about products or services.

In one embodiment, for taking the time to update the information profile, the agent can reward the established client with a heritage record, such as a heritage book, that can include a list of relatives and a photograph of the established client.

In one embodiment, a central enterprise monitors at least one of the preceding steps to ensure compliance with existing laws and/or provides administrative or other support, such as providing the authorization forms, etc. At least one of the associate business, such as a cemetery or funeral business, and the agent remunerates the central enterprise in consideration for monitoring, and/or providing support.

The method 10 described above can be run under several business models, such as a franchise model. An associate business (franchisee), such as a cemetery or funeral business that employs the agent, remunerates the central enterprise in consideration for being a franchisee of the method 10 and in consideration for monitoring, providing administrative support, etc. Other business models are possible. The central enterprise can, for example, license the associate business to use the method 10 for the purpose of marketing and selling the cemetery business and related products. It should be further understood that the associate business can include an incorporated company, an individual, or a sole or joint proprietorship. The agent may constitute the entire workforce of the associate business. The associate business may enter into a separate agreement, such as a sales license agreement, with the agent of the associate business. Under such an agreement, the agent pays a license fee to the central enterprise.

The information profile can be used in a related method of generating clientele by an agent of a business prohibited from direct solicitation. In particular, the method includes the agent meeting a client of the business to update an information profile of the client, and at the meeting, obtaining authorization from the client to provide information about products and services of the business to the client.

As will now be described, the aforementioned heritage record can also be used to generate clientele for a cemetery business.

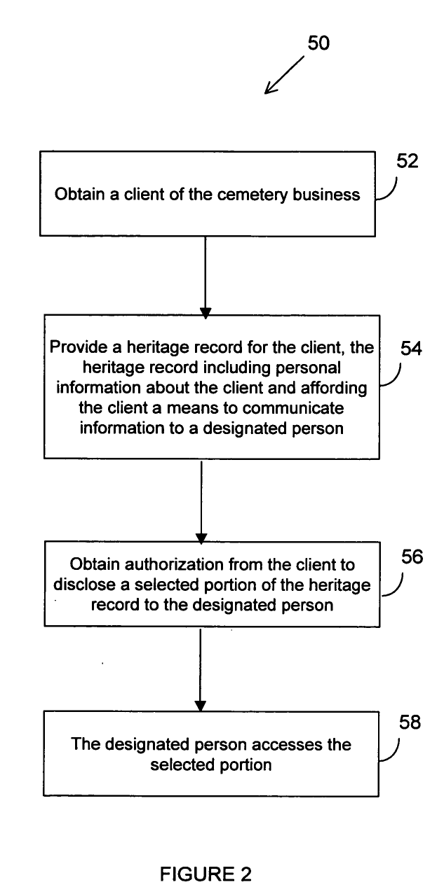

FIG. 2 shows a flowchart of a method 50 for generating clientele by using the heritage record. In step 52, a client of the cemetery business is obtained. In step 54, a heritage record is provided to the client. The heritage record can be a heritage book that includes personal information about the client. The heritage record affords the client a means to communicate information to a designated person, such as a relative, upon the death of the client, or at any other time.

In step 56, authorization is obtained from the client to disclose a selected portion of the heritage record to the designated person. The selected portion may only be a small fraction of the contents of the heritage record. For example, the client may only want to reveal the burial plot location to the designated person. In addition, the client can authorize one designated person to view one portion of the heritage record, and authorize a second designated person to view a different portion. In step 58, the designated person accesses the selected portion.

The step 58 of accessing affords the cemetery business an opportunity to market at least one of its products and services to the designated person. For example, the client may be deceased when a relative visits the cemetery business to obtain more information about the deceased, such as date of birth or death. If the deceased has provided authorization for the relative to view such information, the agent can reveal that portion of the heritage record containing that information. Instead of this authorization from the deceased, the authorization can also be provided by an executor or executrix, or other person or entity that by law has authority to obtain personal information of the deceased.

The agent can also use this opportunity to market the cemetery business. Thus, the agent may ask the relative if the cemetery business may provide or send information about products and services to the relative. If the relative wishes to receive such products or services immediately or in the future, the agent obtains proper authorization from the relative to do so.

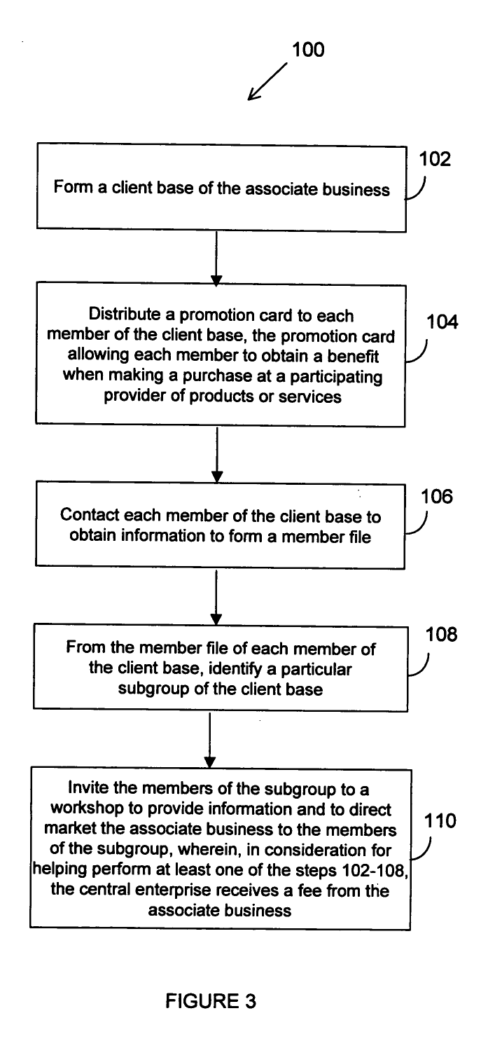

FIG. 3 shows a flowchart of a method 100 for generating fees for a central enterprise from an associate business, such as a cemetery or funeral business. In step 102, a client base is formed of the associate business. In step 104, a promotion card is distributed to each member of the client base, the promotion card allowing each member to obtain a benefit when making a purchase at a participating supplier of products or services. For example, the benefit can include at least one of a discount for the purchase, points for a frequent purchase program and a contribution to charity. To defer some of the costs of producing the promotion cards, the card can include an advertisement of the participating supplier.

In step 106, each member of the client base is contacted to obtain information to form a member file. From the member file of each member of the client base, a particular subgroup of the client base is identified in step 108. Subsequently, in step 110, the members of the subgroup are invited to a workshop to provide information and to direct market the associate business to the members of the subgroup. The workshop can be a tea workshop and can include a social component, where food and/or beverages are provided, for example. In addition, a guest speaker can give a talk at the workshop. Moreover, prizes can be awarded to the guests of the workshop.

In consideration for helping perform at least one of the steps 102-110, the central enterprise receives a fee from the associate business.

In one variation of the method 100, step 108 includes, from the member file of each member of the client base, identifying a particular subgroup of the client base sharing a common characteristic. At least one of the information and the direct marketing mentioned in step 110 may be based on the common characteristic.

The method 100 may further include at least one of the central enterprise, the associate business and the participating supplier providing a donation to a charity with each purchase at the participating supplier. The charity can be chosen by the member making the purchase.

It should be understood that various modifications and adaptations could be made to the embodiments described and illustrated herein, without departing from the present invention. For example, although emphasis has been placed on describing methods for cemetery or funeral businesses, other types of businesses can benefit from the methods described herein. The scope of the invention is defined by the following claims.

1. A method of generating clientele by an agent of a business prohibited from direct solicitation, the method comprising
the agent requesting from an established client of the business a referral for a prospective client;
the established client referring the prospective client to the business;
in response to the step of referring, the prospective client contacting the business; and
a representative of the business obtaining authorization from the prospective client to provide information about products and services of the business.

2. The method of claim 1, wherein the business is at least one of a cemetery business or a funeral business.

3. The method of claim 1, wherein the step of obtaining includes the representative meeting the prospective client, the authorization obtained during the meeting.

4. The method of claim 3, wherein the step of obtaining further includes the established client accompanying the prospective client during the meeting.

5. The method of claim 1, wherein the agent and the representative coincide.

6. The method of claim 1, wherein the prospective client is a relative of the established client.

7. The method of claim 1, further comprising, before the step of requesting a referral,
the agent personally meeting with the established client of the business; and
at the meeting, updating an information profile of the established client, wherein the agent executes the step of requesting at the meeting.

8. The method of claim 7, wherein the prospective client is a relative or acquaintance of the established client.

9. The method of claim 8, wherein the information profile of the established client contains some data associated with the relative or acquaintance, respectively.

10. The method of claim 9, further comprising
the agent asking the established client a question about the relative or acquaintance, wherein the question can be used as a segue for the step of requesting a referral.

11. The method of claim 7, wherein, at the meeting, the agent provides a heritage record to the established client, the heritage record including at least one of a list of relatives and a photograph of the established client.

12. The method of claim 11, further comprising
a central enterprise monitoring at least one of the preceding steps to ensure compliance with existing laws; and
at least one of the business and the agent remunerating the central enterprise in consideration for the step of monitoring.

13. The method of claim 11, further comprising
a central enterprise providing support; and
at least one of the business and the agent remunerating the central enterprise in consideration for the step of providing support.

14. The method of claim 1, further comprising, before the step of obtaining, the established client providing an authorization form to the prospective client, wherein the prospective client provides the authorization to the business by signing the authorization form.

15. A method of generating fees for a central enterprise from an associate business, the method comprising
a) forming a client base of the associate business;
b) distributing a promotion card to each member of the client base, the promotion card allowing each member to obtain a benefit when making a purchase at a participating supplier of products or services;
c) contacting each member of the client base to obtain information to form a member file;
d) from the member file of each member of the client base, identifying a particular subgroup of the client base; and
e) inviting the members of the subgroup to a workshop to provide information and to direct market the associate business to the members of the subgroup, wherein, in consideration for helping perform at least one of the steps a)-d), the central enterprise receives a fee from the associate business.

16. The method of claim 15, wherein step d) includes, from the member file of each member of the client base, identifying a particular subgroup of the client base sharing a common characteristic, and wherein at least one of the information and the direct marketing is based on the common characteristic.

17. The method of claim 16, wherein the benefit includes at least one of a discount for the purchase, points for a frequent purchase program and a contribution to charity.

18. The method of claim 15, further comprising:
at least one of the central enterprise, the associate business and the participating supplier providing a donation to a charity with each purchase at the participating supplier.

19. The method of claim 18, wherein the charity can be chosen by the member making the purchase.

20. The method of claim 15, wherein the associate business is at least one of a cemetery business and a funeral business.

21. The method of claim 15, wherein the promotion card can include an advertisement of the participating supplier.

22. A method of generating clientele for a cemetery business, the method comprising
obtaining a client of the cemetery business;
providing a heritage record for the client, the heritage record including personal information about the client and affording the client a means to communicate information to a designated person; and
obtaining authorization from the client to disclose a selected portion of the heritage record to the designated person.

23. The method of claim 22, wherein the client and the designated person are related.

24. The method of claim 22, further comprising the designated person accessing the selected portion.

25. The method of claim 24, wherein the step of accessing affords the cemetery business an opportunity to market at least one of its products and services to the designated person.

26. The method of claim 22, wherein the client is deceased when the designated person accesses the selected portion.

27. The method of claim 26, wherein the selected portion includes burial plot information of the deceased client.

28. A method of generating clientele by an agent of a business prohibited from direct solicitation, the method comprising
the agent meeting a client of the business to update an information profile of the client; and
at the meeting, obtaining authorization from the client to provide information about products and services of the business to the client.

29. The method of claim 28, wherein the business includes at least one of a cemetery business and a funeral business.
